(19) United States
(12) Patent Application Publication
(10) Pub. No.: US 2009/0057558 A1
(43) Pub. Date: Mar. 5, 2009

(54) SCANNING ELECTRON MICROSCOPE

(75) Inventors: Toru Iwaya, Hitachinaka (JP); Kenichi Hirane, Hitachi (JP); Tomohisa Ohtaki, Hitachinaka (JP)

Correspondence Address: MCDERMOTT WILL & EMERY LLP, 600 13TH STREET, N.W., WASHINGTON, DC, 20005-3096, US

(73) Assignees: HITACHI; HIGH-TECHNOLOGIES CORPORATION

(21) Appl. No.: 12/194,141

(22) Filed: Aug. 19, 2008

(30) Foreign Application Priority Data
Aug. 27, 2007 (JP) 2007-220088

(51) Int. Cl. G01N 23/00

(52) U.S. Cl. 250/311

(57) ABSTRACT

An object of the invention is provide a scanning electron microscope including a permanent magnet forming a condenser lens with a variable value of probe current.

To achieve the object, the scanning electron microscope including the permanent magnet forming the condenser lens as an embodiment of the invention, includes a mechanism for adjusting a distance between an electron source and an anode electrode. Further, the mechanism for adjusting the distance between the electron source and the anode electrode, includes a removable spacer arranged under a lower portion of the anode electrode.

### BACKGROUND OF THE INVENTION

The present invention relates to a scanning electron microscope, particularly an electron gun for the scanning electron microscope of compact size.

In a conventional scanning electron microscope, a condenser lens is an electromagnetic lens to adjust a condition of magnetic excitation so that the scanning electron microscope is used with both of relatively small current for high resolution and relatively large current for analysis.

On the other hand, in an inexpensive compact scanning electron microscope with no use for the analysis, as disclosed by JP-A-59-86145, a conventional condenser lens including a permanent magnet is used. However, since the condenser lens is formed by the permanent magnet, a magnitude of magnetic field is not adjustable to case a problem of that a probe current is not increased sufficiently.

Electron-iron beam handbook (3th edition) published on Oct. 28, 1998 from Nikkan kogyo shinbun Ltd. discloses at page 158 that a distance between an Wehnelt electrode and an anode electrode is decreased to obtain an optimum shape of an electrode of electron source so that a surface potential on an optical axis is increased. However, after determining the shape, the surface potential is not adjustable.

### BRIEF SUMMARY OF THE INVENTION

An object of the present invention is to provide a scanning electron microscope in which a value of probe current is adjustable while a condenser lens is formed by a permanent magnet.

According to the invention, to achieve the above object, a mechanism for adjusting a distance between an electron source and an anode electrode is arranged while the condenser lens is formed by the permanent magnet.

Further, the mechanism for adjusting the distance between the electron source and the anode electrode has a spacer arranged under the anode.

According to the invention, the scanning electron microscope in which the condenser lens formed by the permanent magnet, and the value of probe current is adjustable to enable an measurement such as X-ray analysis or the like to be done, is provided.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWINGS

FIG. 1 is a longitudinally cross sectional view showing a main arrangement of a scanning electron microscope for strong magnetic excitation.

FIG. 2 is a longitudinally cross sectional view showing a main arrangement of the scanning electron microscope for weak magnetic excitation.

FIG. 3 is a longitudinally cross sectional view an embodiment of the scanning electron microscope.

### DETAILED DESCRIPTION OF THE INVENTION

An embodiment of the invention is described below with making reference to the drawings.

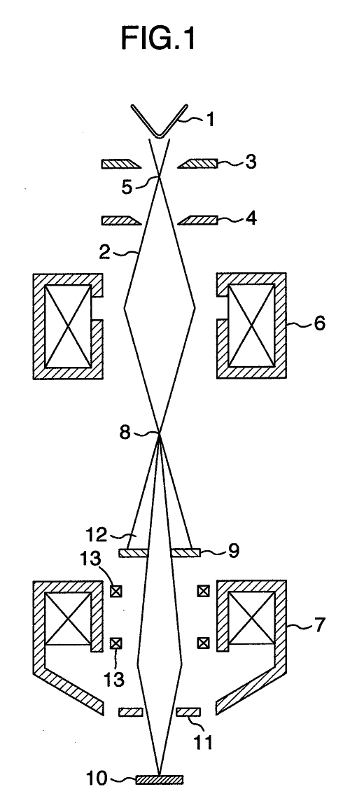

FIG. 1 is a longitudinally cross sectional view showing a main arrangement of a scanning electron microscope for strong magnetic excitation, and shows a trajectory of electron beam obtained when a condenser lens is under the strong magnetic excitation. A vacuum chamber, a deflecting device for the electron beam and a detector is eliminated from FIG. 1.

A principle of the scanning electron microscope is described with making reference to FIG. 1.

After an inside of the scanning electron microscope is vacuumed to reach a desired vacuum pressure, a high voltage is applied to an electron source 1. An electron beam 2 generated by the electron source 1 is converged by an electric field of an Wehnelt electrode 3 to form a first crossover 5 between the Wehnelt electrode 3 and an anode electrode 4.

The electron beam 2 is accelerated by the anode electrode 4, and converged by a condenser lens 6 to form a second crossover 8 between the condenser lens 6 and an objective lens 7. The electron beam 2 is converged by the objective lens 7 after an excessive part of the electron beam 2 is removed by a condenser aperture 9, and is applied to a surface of a specimen on a specimen table 10.

For generating an image of the specimen, a surface of the specimen is scanned by the electron beam 2 deflected by a deflector 13, because the electron beam 2 is converged by the condenser lens 6 and the objective lens 7.

The electron beam 2 applied to the surface of specimen generates a backscattered electron reflected by the surface of specimen and charged particles such as secondary electron emitted from the surface of specimen. The backscattered electron or secondary electron is received by the detector (not shown) arranged in the specimen chamber, and an output of the detector passes an amplifying circuit and is converted to a digital signal to be transmitted to a display so that an image of the surface of specimen is displayed.

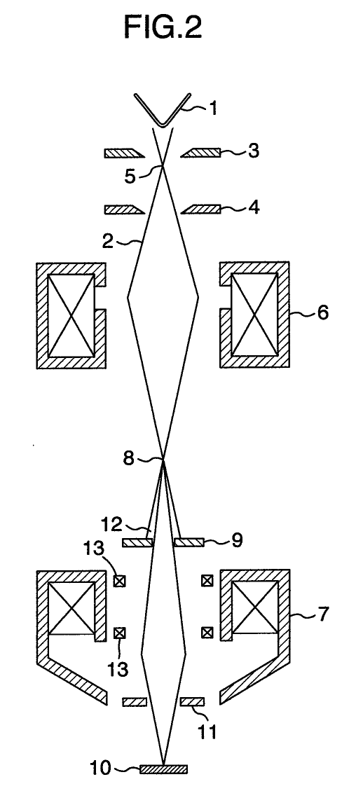

FIG. 2 is a longitudinally cross sectional view showing a main arrangement of the scanning electron microscope for weak magnetic excitation, and shows a trajectory of electron beam obtained when the condenser lens is under the weak magnetic excitation.

Since a current for magnetically exciting the condenser lens is small, a loss of the electron beam caused by the condenser aperture 9 is small so that the probe current is increased. Under the condition of FIG. 2, since the probe current is increased, the scanning electron microscope is usable for the X-ray analysis or the like.

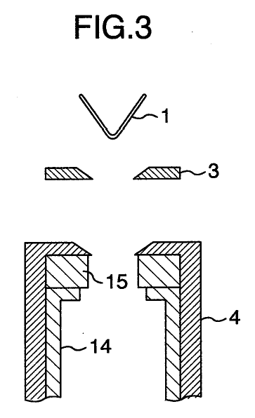

FIG. 3 is a longitudinally cross sectional view an embodiment of the scanning electron microscope.

In the embodiment of the invention, the condenser lens of the scanning electron microscope is formed by a permanent magnet so that the probe current is not adjustable. Therefore, as shown in FIG. 3, a mechanism for adjusting a distance between the electron source 1 and the anode electrode 4 to adjust the probe current is used.

As an example, a spacer 15 is arranged between a lower part of the anode electrode 4 and a part 14 of a chassis, and a thickness of the spacer 15 is increased to decrease the distance between the electron source 1 and the anode electrode 4 so that a surface potential on an optical axis is increased. At least one of the spacer 15 removable and the spacer 13 exchangeable to change the thickness of the spacer is usable to adjust the distance between the electron source 1 and the anode electrode 4 so that the surface potential on the optical axis is adjusted. In addition thereto, the probe current is increased appropriately for condition for the analysis or the like. The scanning electron microscope is usable for an observation for long term when the spacer 15 is not used, and is usable for the analysis with large current when the spacer 13 is used.

As described above, according to the embodiment of the invention, the compact scanning electron microscope in which the condenser lens is formed by the permanent magnet, and the probe current for each of the observation and the analysis is obtained, is provided.

It should be further understood by those skilled in the art that although the foregoing description has been made on embodiments of the invention, the invention is not limited thereto and various changes and modifications may be made without departing from the spirit of the invention and the scope of the appended claims.

1. A scanning electron microscope for applying an electron beam to a specimen to detect a charged particle emitted from the specimen so that an image of the specimen is formed, comprising,
an electron source for generating the electron beam,
an anode electrode for accelerate the electron beam generated by the electron source,
a permanent magnet forming a condenser lens for converging the electron beam,
an objective lens for focusing the electron beam on the specimen,
a deflecting device for moving the electron beam to scan the specimen, and
a mechanism for adjusting a distance between the electron source and the anode electrode.

2. The scanning electron microscope according to claim 1, wherein the mechanism includes a spacer arranged under the anode electrode to decrease a distance between the anode electrode and the electron source.
